(19) United States
(12) Patent Application Publication
(10) Pub. No.: US 2015/0010029 A1
(43) Pub. Date: Jan. 8, 2015

(54) Laser Pulse Shaping Method

(71) Applicant: FREIE UNIVERSITAET BERLIN, BERLIN (DE)

(72) Inventors: Albrecht Lindinger, Teltow (DE); Karsten Heyne, Grossbeeren (DE)

(73) Assignee: FREIE UNIVERSITAET BERLIN, BERLIN (DE)

(21) Appl. No.: 14/373,388

(22) PCT Filed: Jan. 17, 2013
(86) PCT No.: PCT/DE2013/200002

§ 371 Date: Jul. 21, 2014

(30) Foreign Application Priority Data
Jan. 20, 2012 (DE) 102012200858.6

(51) Int. Cl. H01S 3/10; H01S 3/11

(52) U.S. Cl. CPC H01S 3/10061; H01S 3/11
USPC 372/27

(57) ABSTRACT

A laser pulse shaping method is configured for microscopically viewing and modifying an object. A temporal modulation and a two-dimensional spatial modulation of laser pulses are carried out. At least the phase of the laser pulses is modulated dependent on the location, and the modulated laser pulses are directed at the object.

The invention relates to a laser pulse shaping method for the microscopic observation or modification of an object.

The so-called STED (stimulated emission depletion) method, by means of which resolutions below the refractive limit can be achieved (cf. W. Hell and J. Wichmann, Opt. Lett. 19, 780-782 (1994)), is known in the field of microscopy methods. In this method, molecules of the object to be examined are excited into a higher state by means of a first Gaussian laser beam. A ring-shaped second laser beam is superposed on the first laser beam which de-excites the molecules in the outer ring region back into the ground state such that, effectively, only the inner part of the Gaussian profile remains as actually effective excitation profile. In the already known method, there is the problem that two laser beams have to be superposed relatively precisely on one another in order to achieve the desired improvement in resolution.

The invention is therefore based on the object of specifying a laser pulse shaping method which can be carried out with a high resolution but nevertheless in a simple and reproducible manner.

According to the invention, this object is achieved by a laser pulse shaping method having the features in accordance with patent claim 1. Advantageous embodiments of the laser pulse shaping method according to the invention are specified in the dependent claims.

According to this, provision is made, according to the invention, for there to be a temporal modulation and a two-dimensional spatial modulation of laser pulses, wherein at least the phase of the laser pulses is modulated in a spatially dependent manner and the modulated laser pulses are directed at the object.

A substantial advantage of the laser pulse shaping method according to the invention consists of it being possible, in a particularly simple manner, to assign a phase and hence a temporal structure to each spatial point in the object plane due to the provision according to the invention of temporal and two-dimensional spatial modulation of the laser pulses. Using this, it is possible to obtain virtually arbitrary spatially two-dimensional pulse distributions without having to carry out a beam adjustment of two beams—as is the case in the previously known method described at the outset.

A further substantial advantage of the laser pulse shaping method according to the invention should be seen in the fact that time-dependent amplitude and polarization values can optionally also be assigned to the spatial points without much outlay.

With respect to carrying out the two-dimensional spatial modulation, it is considered to be advantageous if a two-dimensional laser pulse field is formed and at least the phase of the two-dimensional laser pulse field is modulated in a spatially dependent and time-dependent manner.

The phase of the laser pulses is preferably modulated in a spatially dependent and time-dependent manner within the scope of the two-dimensional spatial modulation of the laser pulses.

In addition to a phase modulation, it is also possible to carry out an amplitude modulation and/or polarization modulation; accordingly, it is considered to be advantageous if the amplitude and/or the polarization is modulated at a predetermined number of spatial points in the two-dimensional laser pulse field.

A temporal modulation and a two-dimensional spatial modulation of the laser pulses can be carried out in a particularly simple and therefore advantageous manner if a temporal modulation of the laser pulses is carried out by virtue of a laser beam transmitting the laser pulses being modulated in time, and, after the temporal modulation of the laser beam, the laser beam is spatially split in two dimensions forming a multiplicity of laser partial beams which, together, form the two-dimensional spatial laser pulse field, and the phase of the individual laser partial beams is modulated in a spatially dependent and time-dependent manner.

The modulated laser pulses are preferably directed at the object to be observed by virtue of the modulated laser pulses being focused in the focal plane by means of a collecting lens or a collecting mirror.

Alternatively or additionally, the modulated laser pulses can be coupled into a confocal microscope.

The laser pulse shaping method is preferably characterized in that optical secondary waves, which are generated by the observed object due to the incident modulated laser pulses, are evaluated.

Within the meaning of this application, modification means that the object is not only observed but also influenced.

Therefore, molecular processes can be tracked over time and/or initiated by means of the claimed method and/or molecular structures can be spatially modified e.g. in the nanometer range by laser-induced reactions.

Within the meaning of the application, molecular processes means processes on a molecular level, such as e.g. the binding of molecules to form larger molecule complexes or else the breaking up of molecular bonds, as well as the de-excitation or excitation of molecules, such as e.g. the ionization of molecules.

By way of example, the modulated laser pulses are used to generate chemical reactions in volumes under the diffraction limit, as a result of which materials (e.g. polymers) can be modified in a targeted manner on an order of a few nanometers. Using these laser pulses, materials are modified or microstructured with a resolution below the diffraction limit on a scale of a few nanometers. During the production and processing of materials in the nanometer range or larger, the laser pulse train is successively moved over a large region in order to generate large contiguous structures with nanometer resolution. Highly resolved structuring of materials is known e.g. in the case of polymerization by the work by L. Li et al., Science, 324, 910-913. There, polymers are formed with a resolution below the diffraction limit by suitable laser light excitation and de-excitation without temporal modulation. In the present invention, this is improved by an additional suitable temporal modulation.

By way of example, the method can be used within the scope of an STED method; in this respect, it is considered advantageous if the laser pulse is modulated in space and time in such a way that a laser pulse structure is impressed on the outer part of the excited sample volume, leading to the efficient deactivation of the excited molecules, and/or a laser pulse structure with as little deactivation of the excited molecules as possible is impressed on the inner part of the excited sample volume. By shaping the excitation pulses, this approach enables an increase in efficiency of the fluorescence and a targeted selection of molecules. By way of example, if molecules which exhibit different fluorescence dynamics in different surroundings are excited, molecules can thus be selected in a targeted manner for fluorescence in predetermined surroundings. This additionally increases the information content of the spectroscopic process.

For application in an STED method, the laser pulse is preferably modulated in space and time in such a way that the deactivating laser pulse part has a different polarization to the exciting laser pulse part and the two parts can be shaped differently by the modulation apparatus.

In order to achieve ideal laser pulse shaping or laser pulse modulation, it is considered to be advantageous if an iterative optimization method is carried out. With respect to such an iterative optimization method, it is considered advantageous if optical secondary waves, which are generated by the observed object due to the incident modulated laser pulses, are evaluated and the phase modulation, amplitude modulation and/or polarization modulation of the laser pulses is modified within the scope of the iterative optimization method until the received optical secondary waves have a predetermined behavior or lie within a predetermined scope of behavior.

The iterative optimization method is particularly preferably carried out in accordance with an evolutionary algorithm.

The invention moreover relates to a device for microscoping an object using a modulation apparatus which enables a temporal and two-dimensional spatial modulation of laser pulses, in which the phase of the laser pulses is modulated in a spatially dependent manner.

In relation to the advantages of the device according to the invention, reference is made to the explanations set forth above in conjunction with the laser pulse shaping method according to the invention since the advantages of the laser pulse shaping method according to the invention substantially correspond to those of the device according to the invention.

The modulation apparatus is preferably suitable for enabling a temporal and two-dimensional spatial modulation of laser pulses, in which the amplitude and polarization of the laser pulses are modulated in a spatially dependent and time-dependent manner.

Moreover, the invention relates to a storage medium with a program stored thereon, which program, after installation on a computer, causes the computer to carry out a laser pulse shaping method—as described above—and/or an iterative optimization method with or without an evolutionary algorithm for such a laser pulse shaping method.

In relation to the advantages of the storage medium according to the invention, reference is made to the explanations set forth above in conjunction with the laser pulse shaping method according to the invention since the advantages of the storage medium according to the invention substantially correspond to those of the laser pulse shaping method according to the invention.

The invention moreover relates to a microscopy method for the microscopic observation of an object, in which

there is a temporal modulation and a two-dimensional spatial modulation of laser pulses, wherein at least the phase of the laser pulses is modulated in a spatially dependent manner,

the modulated laser pulses are directed at the object and

optical secondary waves, which are generated by the observed object due to the incident modulated laser pulses, are evaluated.

In relation to the advantages of the microscopy method according to the invention, reference is made to the explanations set forth above in conjunction with the laser pulse shaping method according to the invention.

The invention moreover relates to a microscopy device for microscoping an object using a modulation apparatus which enables a temporal and two-dimensional spatial modulation of laser pulses, in which at least the phase of the laser pulses is modulated in a spatially dependent manner.

In relation to the advantages of the microscopy device according to the invention, reference is made to the explanations set forth above in conjunction with the laser pulse shaping method according to the invention since the advantages of the laser pulse shaping method according to the invention substantially correspond to those of the microscopy device according to the invention.

In the following, the invention will be explained in more detail on the basis of two exemplary embodiments; here, in an exemplary manner,

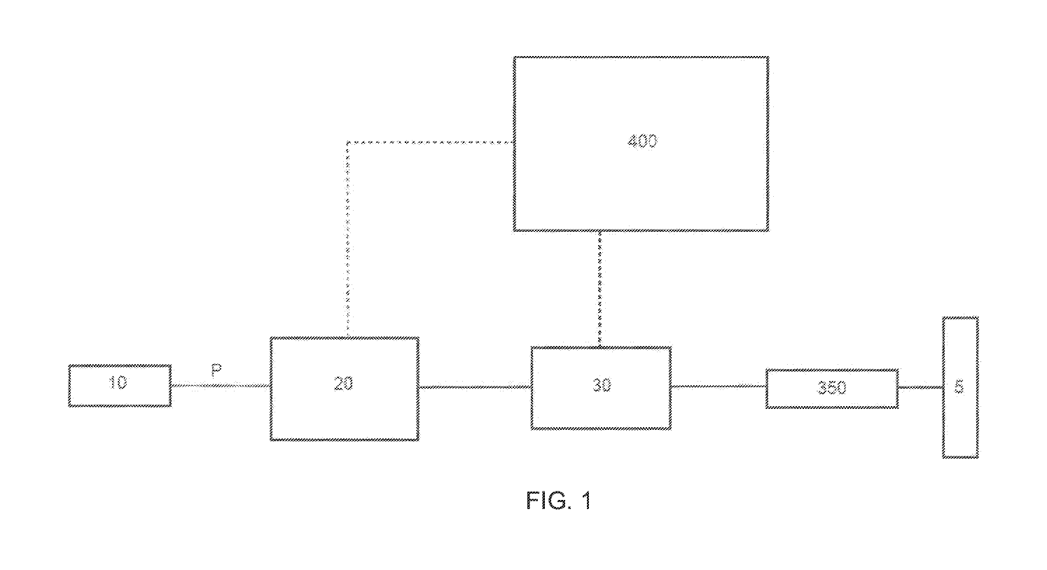

FIG. 1 shows schematic illustration of the device for carrying out the laser pulse shaping method according to the invention,

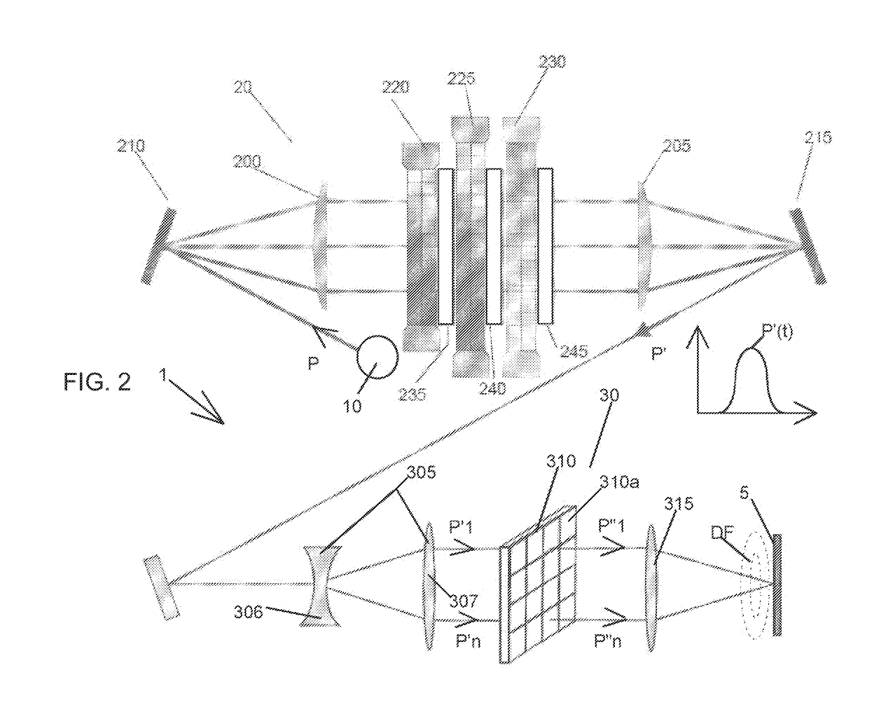

FIG. 2 shows a first exemplary embodiment of a laser pulse shaping device according to the invention, on the basis of which the laser pulse shaping method according to the invention is also explained in an exemplary manner, and

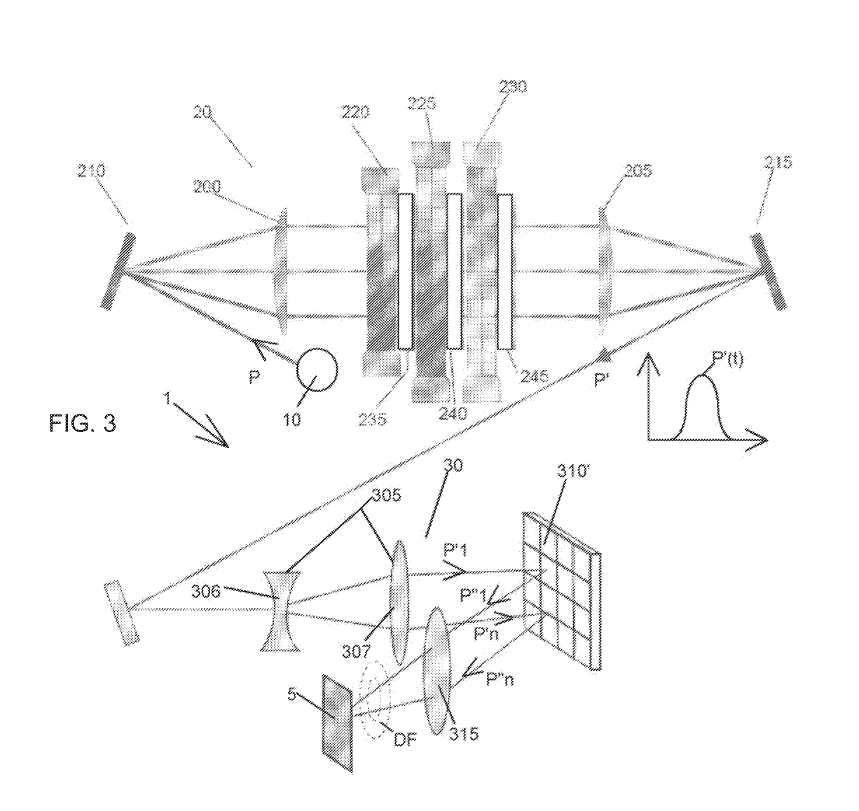

FIG. 3 shows a second exemplary embodiment of a laser pulse shaping device according to the invention.

For reasons of clarity, identical or comparable components are always provided with the same reference signs in the figures.

FIG. 1 shows a schematic illustration of the device 1 for carrying out the laser pulse shaping method according to the invention. The laser beam P of the laser pulse source 10 is initially shaped by a first pulse modulator 20 and then by a second pulse modulator 30, before it is directed at the object . The laser pulse is shaped in time by the first pulse modulator 20 and in space by the second pulse modulator 30. Optionally, an additional optical element 350 focuses the shaped laser pulse onto the object 8 A computer 400 can actuate the first pulse modulator 20 and the second pulse modulator 30.

FIG. 2 shows a device 1 which is suitable for the microscopic observation of an object 5. The device 1 comprises a laser pulse source 10 which, on the output side, generates a laser beam P transmitting laser pulses.

Arranged downstream of the laser pulse source 10 is a first pulse modulation apparatus 20, which carries out a temporal modulation of the laser pulses of the laser beam P. The first pulse modulation apparatus 20 comprises two collecting lenses 200 and 205, two gratings 210 and 215, three double liquid crystal modulators 220, 225 and 230, a polarizer 235 and two λ/2-plates 240 and 245.

In relation to the polarization axis of the polarizer 235, the two λ/2-plates 240 and 245 are preferably aligned at an angle of −22.5°. By way of example, the three liquid crystal modulators 220, 225 and 230 can be SLM1280 or SLM256-type modulators.

Arranged downstream of the first pulse modulation apparatus 20 is a second pulse modulation apparatus 30, which, in two dimensions, spatially modulates the phase of the laser beam P′ modulated by the first pulse modulation apparatus 20 in time. To this end, the second pulse modulation apparatus 30 comprises an expansion apparatus 305, a two-dimensional phase modulator 310 and a collecting lens 315. The function of the expansion apparatus 305 consists of expanding the time-modulated laser beam P′ arriving on the input side and of generating a two-dimensional laser pulse field which is formed by a multiplicity of laser partial beams. For reasons of clarity, only two laser partial beams of the laser partial beams forming the two-dimensional laser pulse field have been denoted by reference signs, namely the laser partial beams P′1 and P′n, in FIG. 2.

The expansion apparatus 305 comprises two lenses 306 and 307 for expanding the time-modulated laser partial beam P′ or for forming the two-dimensional laser pulse field.

The laser partial beams P′1-P′n formed by the expansion apparatus 305 reach the two-dimensional phase modulator 310 which carries out a spatially two-dimensional phase modulation of the laser partial beams. In FIG. 2, the phase-modulated laser partial beams are denoted by the reference signs P″1-P″n.

For the purposes of phase modulation, the two-dimensional phase modulator 310 can in each case have a transparent material in each modulation segment 310a, which material is modulated in terms of the refractive index thereof by applying a voltage individual to the modulation segment. Additionally or alternatively, there can also be a change in the polarization and/or in the amplitude individual to the modulation segment in each modulation segment 310a.

The phase-modulated laser partial beams generated by the two-dimensional phase modulator 310 arrive at the collecting lens 315, which focuses the laser partial beams P″1-P″n onto the object 5.

The laser partial beams focused by the collecting lens 315 onto the object 5 generate secondary waves on or in the object 5 to be observed, which secondary waves can be registered and evaluated by means of an observation unit not depicted in any more detail in FIG. 2 for reasons of clarity. The optical secondary waves can be registered and evaluated with the aid of conventional components and apparatuses, as in known e.g. from the previously known STED method mentioned at the outset.

The shows a schematic illustration of a device for carrying out the laser pulse shaping method according to the invention. The device 1 in accordance with FIG. 2 is preferably operated in such a way that a predetermined time profile of the pulses of the time-modulated laser beam P′ is generated using the first pulse modulation apparatus 20. In FIG. 2, the generated temporal pulse profile is symbolized in an exemplary manner by a profile P′(t).

A predetermined spatial laser pulse distribution, as is symbolized in an exemplary manner in FIG. 2 by a donut shape DF, is achieved using the second pulse modulation apparatus 30, in particular with the aid of the two-dimensional phase modulator 310. Naturally, the shown donut shape DF should only be understood as exemplary; naturally, a different spatial pulse shape can be achieved by a different phase modulation with the aid of the phase modulator 310.

In the exemplary embodiment in accordance with FIG. 2, the first pulse modulation apparatus 20 and the second pulse modulation apparatus 30 form a modulation apparatus which enables a temporal and two-dimensional spatial modulation of laser pulses, in which the phase of the laser pulses is modulated in a spatially dependent and time-dependent manner. In the exemplary embodiment, it is only a phase modulation that is carried out with the aid of the two-dimensional phase modulator 310 for spatial pulse shape forming; naturally, it is also possible to additionally modulate the amplitude and the polarization of the laser pulses in a spatially dependent and time-dependent manner if a two-dimensional amplitude, polarization and phase modulator is used in place of the two-dimensional phase modulator 310.

The method of operation of the first pulse modulation apparatus 20, which is also shortened to temporal pulse shaper below, and that of the second pulse modulation apparatus 30, which is also shortened to spatial pulse shaper below, can be described mathematically as follows:

First Pulse Modulation Apparatus 20 (Temporal Pulse Shaper):

The temporal form of the electric field of the laser beam P is determined in the Fourier plane by the inverse Fourier transform of the spectral components:

$$\tilde{E} ( t ) = \frac{1}{2 π} \int E ( ω ) {e}^{i ω t} d ω .$$

The following is obtained for the outgoing field by a phase and amplitude modulation in the Fourier plane:

$${\tilde{E}}_{out} ( t ) = \frac{1}{2 π} \int R ( ω ) {e}^{iΦ ( ω )} {\tilde{E}}_{in} ( ω ) {e}^{i ω t} d ω .$$

Polarization shaping can also be achieved by an appropriate modulation.

Thus, a phase, amplitude and polarization, which can be shaped simultaneously and independently, are therefore assigned to each frequency (more precisely to each frequency band assigned to a liquid crystal element in the case of a liquid crystal pulse shaper).

Second Pulse Modulation Apparatus 30 (Spatial Pulse Shaper):

In the case of Fourier beam shaping, the collimated and time-modulated laser beam P′ is modulated by a two-dimensional phase modulator 310 of the second pulse modulation apparatus 30 and subsequently imaged in the focal plane of the object 5 by means of a collecting lens 315 of the second pulse modulation apparatus 30. If the phase modulator 310 is positioned at a distance of one focal length upstream of the collecting lens 315, the image can be described by the following Fourier transform:

$${\tilde{E}}_{out} ( u , v ) = c \int \int H ( x , y ) {e}^{- iΘ ( x , y )} {E}_{in} ( x , y ) {e}^{- 2 π ( \frac{ux}{f λ} + \frac{vy}{f λ} )} d x d y .$$

Here, the position in the focal plane is proportional to the corresponding wave vector Λₓ, Λ_{y}:

u=Λₓfλ; v=Λ_{y}fλ.

The temporal pulse shaper 20 was previously used to assign time-dependent phases, amplitudes and polarizations to the frequencies. Therefore, it is now possible to assign in each case time-dependent phases, amplitudes and polarizations to the different positions in the focal plane. Therefore, this enables an independent temporal modulation of the light field for different points.

In summary, the device 1 in accordance with FIG. 2 can thus, for example, be operated as follows: the spectrally dispersive temporal pulse shaper 20 for temporal pulse shaping is used to assign the phase values, amplitude values and polarization values to frequencies within the spectral width of the pulse or pulses. Subsequently, the spatial pulse shaper 30 is used to modify the spatial profile by means of appropriate phase retardations. The subsequent focusing in the object plane corresponds to a Fourier transform of this spatially modulated light field. As a result, a wave vector representation in the focal plane emerges from the spatial representation. Therefore, the spatial distribution of the light field is assigned to a wave vector distribution. Thus, using this, it is possible, by means of an appropriately modulated preceding spatial distribution, to influence the wave vectors which are directly linked to the frequencies. Therefore, a phase, amplitude and polarization can be assigned to each point in the focal plane within the restrictions predetermined by the apparatus and by the Fourier transform. Therefore, this can be used to track molecular processes by means of temporal changes in an ideal manner. A radial frequency change is advantageous for the STED method, in particular, in order to achieve a flexible and well adapted optical interaction.

The described method can, in particular, be used for different spatial, spectral and temporal shaping of the two light fields for STED microscopy. By way of example, by means of outwardly radially increasing negative linear chirp (in respect of magnitude), the lower frequency components lying further out can be retarded in time. This is preferably brought about by means of a quadratic radial spatial phase. Thus, a red shift of the retarded de-excitation pulse is obtained in this manner. Moreover, a temporal frequency change of the de-excitation transition can be tracked. In order to generate different shapes of excitation and de-excitation pulse, the frequency-dependence of the birefringence can be exploited. By lifting the birefringence for e.g. the excitation pulse, the latter will pass through without modification while, at the same time, the red-shifted de-excitation pulse can be shaped into a ring shape by means of a circular phase. Thus, this enables a Gaussian blue-shifted excitation and a stimulated ring-shaped red-shifted de-excitation within a laser pulse.

The specified pulse shaping in STED microscopy can be improved further by the additionally possible polarization shaping. Thus, for example, a polarization impressed upon a spectral range could differ from one spectral range to the next, and, subsequently, the spectral range with the higher frequency could pass through the birefringent liquid crystal of the spatial pulse shaper 30 with a polarization parallel to the optical axis such that there is no phase retardation, while the spectral range with the lower frequency and polarized perpendicular thereto could be modified by the spatial pulse shaper 30 in a targeted manner. The spatial expansion in the focus accompanying a spatial quadratic phase can moreover be avoided in this manner. Even more flexible and precise pulse shaping can be realized using this.

FIG. 3 shows a second exemplary embodiment for a device 1 according to the invention. The device 1 comprises a first pulse modulation apparatus 20, which corresponds to the pulse modulation apparatus 20 in accordance with FIG. 2. In this respect, reference is made to the explanations above in conjunction with FIG. 2.

Likewise, a second pulse modulation apparatus 30 of the device 1 in accordance with FIG. 3 substantially corresponds to the second pulse modulation apparatus 30 in accordance with FIG. 2; all that is different is the method of operation of the two-dimensional phase modulator 310′. This is because while the two-dimensional phase modulator 310 in accordance with FIG. 2 is operated in transmission operation, the two-dimensional phase modulator 310′ in accordance with FIG. 3 operates in the reflection mode. Therefore, the laser partial beams P′1-P′n incident on the two-dimensional phase modulator 310′ are reflected by the two-dimensional phase modulator 310′ and arrive at a collecting lens 315, which is arranged on the same side of the phase modulator 310 as the expansion apparatus 305. The collecting lens 315 focuses the reflected laser beams P″1-P″n, which are spatially modulated in two dimensions, onto the object 5 to be observed.

By way of example, for the purposes of phase modulation, the two-dimensional phase modulator 310′ can in each case have a transparent material in each modulation segment 310a, which material is modulated in terms of the refractive index thereof by applying a voltage individual to the modulation segment. Additionally or alternatively, there can also be a change in the polarization and/or in the amplitude individual to the modulation segment in each modulation segment 310a. Alternatively, for the purposes of phase modulation, the two-dimensional phase modulator 310′ can in each case have a movable mirror which can be adjusted and therefore brings about a phase modulation by modifying the optical path length in each modulation segment 310.

A phase angle can be created between the laser partial beams P″1-P″n by a suitable actuation of the phase modulator 310, by means of which phase angle a predetermined spatial laser pulse distribution is obtained. By way of example, a donut-shaped or kringle-shaped distribution DF can be obtained, as was already explained in conjunction with FIG. 2. Therefore, in this respect, reference is made to the explanations above in conjunction with FIG. 2.

The methods for temporal and two-dimensional spatial modulation of laser pulses for microscopic purposes, described above in an exemplary manner in conjunction with FIGS. 2 and 3, is depicted schematically in FIG. 1 and preferably characterized by one or more of the following items:
use of a short pulse laser
insertion of the spectrally dispersive pulse shaper design into the beam path for temporal pulse shaping
characterization of the input pulse shape by laser pulse detection instruments (e.g. FROG, autocorrelator, spectrometer)
modification of the pulse shape in respect of amplitude, phase and polarization with the aid of the pulse shaper; passage of the laser beam through liquid crystal arrays and/or acousto-optic modulators and/or dazzlers, which are actuated independently from one another
insertion of the spatially dispersive two-dimensional pulse shaper into the beam path for spatial pulse shaping after the temporal pulse shaping
insertion of a focusing unit, e.g. a collecting lens or a collecting mirror, downstream of the pulse shaping unit
positioning of the spatial pulse shaper in the first image plane of the illumination beam path of the microscope at a distance of one focal length from the first lens of the microscope
spatial pulse shaping with radially dependent frequency components which can be shaped in a time-dependent manner by means of spectral dispersion
combined temporal and spatial pulse shaping by actuation of both pulse modulators
predefined temporal and spatial light fields in the object plane by parametric temporal and spatial pulse shaping using both modulators
use of specially radially shaped pulse profiles in STED microscopy
characterization of the complete shape of the output pulse in terms of amplitude, phase and polarization by laser pulse detection instruments (e.g. FROG, XFROG, PG-FROG, autocorrelator, cross-correlator, spectrometer) and suitably positioned light polarizers
additional option for carrying out an iterative, free or parametric optimization process using evolutionary algorithms
instrument-specific stimulation of the generated pulse shapes with the effects occurring in the process due to the apparatus (such as e.g. pulse replica).

The apparatus-based device 1 for carrying out the laser pulse shaping method, as used for the method, preferably comprises one or more of the following parts or elements:
a short pulse laser, which supplies pulses in the frequency range required for the electronic excitation and microscopy of the molecule to be examined

4f-laser pulse shapers for temporal pulse shaping or acousto-optic modulators or dazzlers
a two-dimensional modulator for spatial laser pulse shaping
an optical element for focusing, e.g. a collecting lens or collecting mirror
a microscope, in particular a confocal microscope
a spatial pulse shaper positioned in the first image plane of a microscope, one focal length upstream of the first lens
a laser pulse detection unit (e.g. FROG, cross-correlation, spectrometer, XFROG)
a computer program for actuating the individual liquid crystal elements of the pulse shapers for generating parametrically described pulse shapes
a computer program for carrying out an iterative parametric optimization process using evolutionary algorithms and for reading out the required pulse parameters from the employed laser pulse detection instruments.

### LIST OF REFERENCE SIGNS

1 Device

5 Object

10 Laser pulse source

20 Pulse modulation apparatus

30 Pulse modulation apparatus

200 Collecting lens

205 Collecting lens

210 Grating

215 Grating

220 Liquid crystal modulator

225 Liquid crystal modulator

230 Liquid crystal modulator

235 Polarizer

240 λ/2-plate

245 λ/2-plate

305 Expansion apparatus

306 Lens

307 Lens

310 Phase modulator

310a Modulation segment

310′ Phase modulator

315 Collecting lens

350 Optical element

400 Computer

DF Spatial donut shape

P Laser beam

P′(t) Temporal pulse shape

P′ Laser beam

P′1 Laser partial beam

P′n Laser partial beam

P″1 Laser partial beam

1-16. (canceled)

17. A laser pulse shaping method for a microscopic observation or modification of an object, the method comprising:
modulating laser pulses with a temporal modulation and a two-dimensional spatial modulation of the laser pulses, wherein at least a phase of the laser pulses is modulated in a spatially dependent manner; and
directing the modulated laser pulses at the object.

18. The laser pulse shaping method according to claim 17, wherein a two-dimensional laser pulse field is formed for carrying out the two-dimensional spatial modulation.

19. The laser pulse shaping method according to claim 18, which comprises modulating the amplitude and/or the polarization at a predetermined number of spatial points in the two-dimensional laser pulse field.

20. The laser pulse shaping method according to claim 17, wherein:
a temporal modulation of the laser pulses is carried out by virtue of a laser beam transmitting the laser pulses being modulated in time, and
after the temporal modulation of the laser beam, the time-modulated laser beam is spatially split in two dimensions forming a multiplicity of laser partial beams which, together, form the two-dimensional spatial laser pulse field, and
the phase of the individual laser partial beams is modulated in a spatially dependent and/or time-dependent manner.

21. The laser pulse shaping method according to claim 17, which comprises focusing the modulated laser pulses in a focal plane of the object by way of an optical element.

22. The laser pulse shaping method according to claim 17, which comprises coupling the modulated laser pulses into a confocal microscope.

23. The laser pulse shaping method according to claim 17, which comprises evaluating optical secondary waves, which are generated by the observed object due to the incident modulated laser pulses.

24. The laser pulse shaping method according to claim 17, wherein:
molecular processes are tracked over time and/or initiated;
and/or materials are spatially modified.

25. The laser pulse shaping method according to claim 17, which comprises performing the method with a resolution in the nanometer range.

26. The laser pulse shaping method according to claim 17, which comprises modulating the laser pulse in space and time for the application in a STED method in such a way that:
a laser pulse structure is impressed on an outer part of an excited sample volume, leading to an efficient deactivation of the excited molecules; and/or
a laser pulse structure with as little deactivation of the excited molecules as possible is impressed on an inner part of the excited sample volume.

27. The laser pulse shaping method according to claim 17, which comprises modulating the laser pulse in space and time for the application in a STED method in such a way that:
a deactivating laser pulse part has a different polarization from an exciting laser pulse part and
the two laser pulse parts can be shaped differently by the modulation apparatus.

28. The laser pulse shaping method according to claim 17, which comprises carrying out an iterative optimization method by evaluating optical secondary waves, which are generated by the observed object due to the incident modulated laser pulses, and modifying the phase modulation, amplitude modulation and/or polarization modulation of the laser pulses within a scope of the iterative optimization method until the received optical secondary waves have a predetermined behavior or lie within a predetermined scope of behavior.

29. The laser pulse shaping method according to claim 17, which comprises modulating the laser pulse in space and time in such a way that:
a deactivating laser pulse part of the laser pulse is impressed on the outer part of an excited sample volume, leading to an efficient deactivation of excited molecules, and
an exciting laser pulse part of the laser pulse with as little deactivation of the molecules as possible is impressed on the inner part of the excited sample volume.

30. The laser pulse shaping method according to claim 29, wherein the deactivating laser pulse part and the exciting laser pulse part are shaped differently.

31. The laser pulse shaping method according to claim 29, wherein the deactivating laser pulse part has a different polarization from the exciting laser pulse part.

32. The laser pulse shaping method according to claim 29, wherein, by means of outwardly radially increasing negative linear chirp, in respect of magnitude, the lower frequency components lying further out are retarded in time, providing a red shift of the deactivating laser pulse part.

33. The laser pulse shaping method according to claim 29, which comprises:
shaping a red-shifted deactivating laser pulse part into a ring shape by means of a circular phase, and
shaping a blue-shifted exciting laser pulse part into a Gaussian shape.

34. A device for carrying out the laser pulse shaping method according to claim 17 using a modulation apparatus which enables a temporal and two-dimensional spatial modulation of laser pulses, in which at least the phase of the laser pulses is modulated in a spatially dependent manner.

35. The device according to claim 34, wherein the modulation apparatus enables a temporal and two-dimensional spatial modulation of laser pulses, in which the amplitude and polarization of the laser pulses are modulated in a spatially dependent and time-dependent manner.

36. A storage medium with a program stored thereon in non-transitory form, which program, after installation on a computer, causes the computer to carry out the method according to claim 17.
